(19) United States
(12) Patent Application Publication
(10) Pub. No.: US 2025/0154023 A1
(43) Pub. Date: May 15, 2025

(54) COMPOSITE CATHODE ACTIVE MATERIAL FOR LITHIUM SECONDARY BATTERY AND A METHOD OF PRODUCING THE SAME

(71) Applicants: Hyundai Motor Company, Seoul (KR); Kia Corporation, Seoul (KR); Research & Business Foundation SUNGKYUNKWAN UNIVERSITY, Suwon-si (KR)

(72) Inventors: Im Sul Seo, Cheongju-si (KR); Hong Seok Min, Yongin-si (KR); Sung Woo Noh, Seoul (KR); Je Sik Park, Seoul (KR); Chung Bum Lim, Suwon-si (KR); Yong Seok Lee, Suwon-si (KR); Joo Young Lee, Pyeongtaek-si (KR); Ju Yeong Seong, Seongnam-si (KR); Jeong Hyun Seo, Daejeon (KR); Jongsoon Kim, Seoul (KR)

(21) Appl. No.: 18/768,242

(22) Filed: Jul. 10, 2024

(30) Foreign Application Priority Data
Nov. 9, 2023 (KR) 10-2023-0154710

(51) Int. Cl. C01G 45/12; H01M 10/0525

(52) U.S. Cl. CPC C01G 45/1257; H01M 10/0525; C01P 2002/72

(57) ABSTRACT

An embodiment composite cathode active material includes a core part configured to enable intercalation and deintercalation of lithium and a shell part configured to cover surfaces of the core part and including an alkali metal oxide, wherein the alkali metal oxide includes a substituent element substituted for a part of an alkali metal and having a greater oxidation number than the alkali metal.

### CROSS-REFERENCE TO RELATED APPLICATIONS

This application claims the benefit of Korean Patent Application No. 10-2023-0154710, filed on Nov. 9, 2023, which application is hereby incorporated herein by reference.

### TECHNICAL FIELD

The present disclosure relates to a composite cathode active material for lithium secondary batteries and a manufacturing method thereof.

### BACKGROUND

Secondary batteries which are rechargeable are used not only in small electronic devices, such as mobile phones and notebook computers, but also in large transportation, such as hybrid vehicles and electric vehicles. Therefore, development of secondary batteries having higher stability and energy density is required.

Most conventional secondary batteries include cells formed based on organic liquid electrolytes, and they are thus limited in terms of improvement in stability and energy density.

Meanwhile, all-solid-state batteries using inorganic solid electrolytes include cells manufactured in a safe and simple type based on the technology of excluding organic solvents, and thus have recently been in the spotlight.

However, the all-solid-state batteries have problems, such as high interfacial resistance and side reaction between a cathode active material and a solid electrolyte. Therefore, a coating layer including an oxide-based compound is applied to the cathode active material so as to relieve the side reaction, but when the all-solid-state battery is operated for a long period of time, the coating layer may be decomposed.

The above information disclosed in this background section is only for enhancement of understanding of the background of the invention, and therefore it may contain information that does not form the prior art that is already publicly known.

### SUMMARY

Embodiments of the present disclosure have been made in an effort to solve problems associated with the prior art, and an embodiment of the present disclosure provides a composite cathode active material for lithium secondary batteries which may relieve high interfacial resistance between the cathode active material and a solid electrolyte and a manufacturing method thereof.

Another embodiment of the present disclosure provides a composite cathode active material for lithium secondary batteries having high chemical adsorption strength and excellent chemical stability and a manufacturing method thereof.

Yet another embodiment of the present disclosure provides a composite cathode active material for lithium secondary batteries having excellent lithium ion conductivity and a manufacturing method thereof.

One embodiment of the present disclosure provides a composite cathode active material for lithium secondary batteries including a core part configured to enable intercalation and deintercalation of lithium and a shell part configured to cover surfaces of the core part and including an alkali metal oxide.

In a preferred embodiment, the alkali metal oxide may include a substituent element substituted for a part of an alkali metal and configured to have a greater oxidation number than the alkali metal.

In another preferred embodiment, the substituent element may include a non-transition metal.

In still another preferred embodiment, the alkali metal oxide may be represented by Chemical Formula 1.

(A₁₋ₐₓBₓ)MO₃ Chemical Formula 1

In Chemical Formula 1, A may include the alkali metal, B may include at least one element selected from the group consisting essentially of magnesium (Mg), aluminum (Al), gallium (Ga), silicon (Si), germanium (Ge), tin (Sn), arsenic (As), antimony (Sb), and combinations thereof, M may include at least one element selected from the group consisting essentially of niobium (Nb), tantalum (Ta), boron (B), zirconium (Zr), phosphorous (P), and combinations thereof, a may indicate an oxidation number of B, and x may satisfy 0.01≤x≤0.3.

In yet another preferred embodiment, the alkali metal oxide may be represented by Chemical Formula 2.

[(A₁₋ₐₓ(B1₁₋ₘB2ₘ)ₓ](M1₁₋ₙM2ₙ)O₃ Chemical Formula 2

In Chemical Formula 2, A may include the alkali metal, B1 and B2 may be different from each other and may independently include at least one element selected from the group consisting essentially of magnesium (Mg), aluminum (Al), gallium (Ga), silicon (Si), germanium (Ge), tin (Sn), arsenic (As), antimony (Sb), and combinations thereof, M1 and M2 may be different from each other and may independently include at least one element selected from the group consisting essentially of niobium (Nb), tantalum (Ta), boron (B), zirconium (Zr), phosphorous (P), and combinations thereof, oxidation numbers of B1 and B2 may be the same, a may indicate the oxidation number of B1 or B2, and m, n, and x may satisfy 0≤m≤1, 0≤n≤1 and 0.01≤x≤0.3.

In still yet another preferred embodiment, the composite cathode active material may include 98 wt % to 99.9 wt % of the core part and 0.1 wt % to 2 wt % of the shell part.

In a further preferred embodiment, the alkali metal oxide may have a crystal structure of a trigonal crystal structure and may belong to an R3c space group.

In another further preferred embodiment, the alkali metal and the substituent element may occupy sites of a Wyckoff position 6a (0,0,0.283).

In still another further preferred embodiment, the substituent element may not occupy sites of a Wyckoff position 6a (0,0,0).

In yet another further preferred embodiment, a unit cell volume of the alkali metal oxide may be reduced depending on substitution of the substituent element for the part of the alkali metal, compared to a case in which there is no substituent element.

In still yet another further preferred embodiment, a length of an axis a of the alkali metal oxide obtained through Rietveld analysis in X-ray diffraction may be decreased depending on substitution of the substituent element for the part of the alkali metal, compared to a case in which there is no substituent element.

In a still further preferred embodiment, a length of an axis c of the alkali metal oxide obtained through Rietveld analysis in X-ray diffraction may be increased depending on substitution of the substituent element for the part of the alkali metal, compared to a case in which there is no substituent element.

In a yet still further preferred embodiment, the alkali metal oxide is one in which a Bragg angle of at least one of (hkl) diffraction peak among (012), (104), (110), and (113) obtained through Rietveld analysis in X-ray diffraction is shifted at a high angle depending on substitution of the substituent element for the part of the alkali metal, compared to a case in which there is no substituent element.

In another further preferred embodiment, the shell part may be a conformal layer.

In still another further preferred embodiment, adsorption energy of the alkali metal oxide to the core part may be increased depending on substitution of the substituent element for the part of the alkali metal, compared to a case in which there is no substituent element.

In yet another further preferred embodiment, activation barrier energy of the alkali metal oxide may be decreased depending on substitution of the substituent element for the part of the alkali metal, compared to a case in which there is no substituent element.

Another embodiment of the present disclosure provides a manufacturing method of the above-described composite cathode active material, including preparing the core part configured to enable intercalation and deintercalation of lithium, preparing raw materials for the alkali metal oxide, acquiring an intermediate by putting the core part and the raw materials into a solvent and agitating the core part and the raw materials in the solvent, drying the intermediate, and heat-treating the dried intermediate.

In a preferred embodiment, the raw materials may include alkoxides of respective elements configured to form the alkali metal oxide.

Yet another embodiment of the present disclosure provides a manufacturing method of the above-described composite cathode active material, including preparing raw materials for the alkali metal oxide, acquiring a ground material by grinding the raw materials using a ball mill, acquiring the alkali metal oxide by heat-treating the ground material, and forming the shell part including the alkali metal oxide on the surfaces of the core part configured to enable intercalation and deintercalation of lithium.

In a preferred embodiment, the raw materials may include oxides of respective elements configured to form the alkali metal oxide.

In another preferred embodiment, in acquiring the ground material, the raw materials may be ground by a high energy ball milling method.

Other aspects and preferred embodiments of the invention are discussed infra.

The above and other features of embodiments of the invention are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a lithium secondary battery according to an embodiment of the present disclosure;

FIG. 2 shows a composite cathode active material according to an embodiment of the present disclosure;

FIG. 3 shows X-ray diffraction analysis results of alkali metal oxides according to Manufacturing Example 1 and Comparative Manufacturing Example 1;

FIG. 4 shows Rietveld analysis results of the alkali metal oxide according to Manufacturing Example 1;

FIG. 5 shows Rietveld analysis results of the alkali metal oxide according to Comparative Manufacturing Example 1;

FIG. 6 shows X-ray photoelectron spectroscopy (XPS) analysis results of Nd 3d of the alkali metal oxide according to Manufacturing Example 1;

FIG. 7 shows XPS analysis results of Nd 3d of the alkali metal oxide according to Comparative Manufacturing Example 1;

FIG. 8 shows XPS analysis results of the alkali metal oxide according to Manufacturing Example 1 in a binding energy range of 0-100 eV;

FIG. 9 shows XPS analysis results of the alkali metal oxide according to Comparative Manufacturing Example 1 in the binding energy range of 0-100 eV;

FIG. 10 shows calculation results of stable potential windows of the alkali metal oxides according to Manufacturing Example 1 and Comparative Manufacturing Example 1;

FIG. 11 shows X-ray diffraction analysis results of alkali metal oxides according to Manufacturing Example 2 and Comparative Manufacturing Example 2;

FIG. 12A shows high resolution transmission electron microscopy (HR-TEM) analysis results of a composite cathode active material according to Manufacturing Example 3;

FIG. 12B shows HR-TEM analysis results acquired at a different magnification from that of FIG. 12A;

FIG. 13A shows HR-TEM analysis results of a composite cathode active material according to Comparative Manufacturing Example 3;

FIG. 13B shows HR-TEM analysis results acquired at a different magnification from that of FIG. 13A;

FIG. 14 shows HR-TEM-energy dispersive spectroscopy (HR-TEM-EDS) analysis results of the composite cathode active material according to Comparative Manufacturing Example 3;

FIG. 15 shows C-rate test results of a lithium ion battery according to Example 1;

FIG. 16 shows C-rate test results of a lithium ion battery according to Comparative Example 1;

FIG. 17 shows measurement results of cycle life and Columbic efficiency of the lithium ion battery according to Example 1;

FIG. 18 shows measurement results of cycle life and Columbic efficiency of the lithium ion battery according to Comparative Example 1;

FIG. 19 shows evaluation results of electrochemical characteristics of an all-solid-state battery according to Example 2; and

FIG. 20 shows evaluation results of electrochemical characteristics of an all-solid-state battery according to Comparative Example 2.

It should be understood that the appended drawings are not necessarily to scale, presenting a somewhat simplified representation of various preferred features illustrative of the basic principles of the embodiments of the invention. The specific design features of the embodiments of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second,” may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including,” “comprising,” and “having”, are to be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected, and thus it will be understood that they are modified by the term “about,” unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

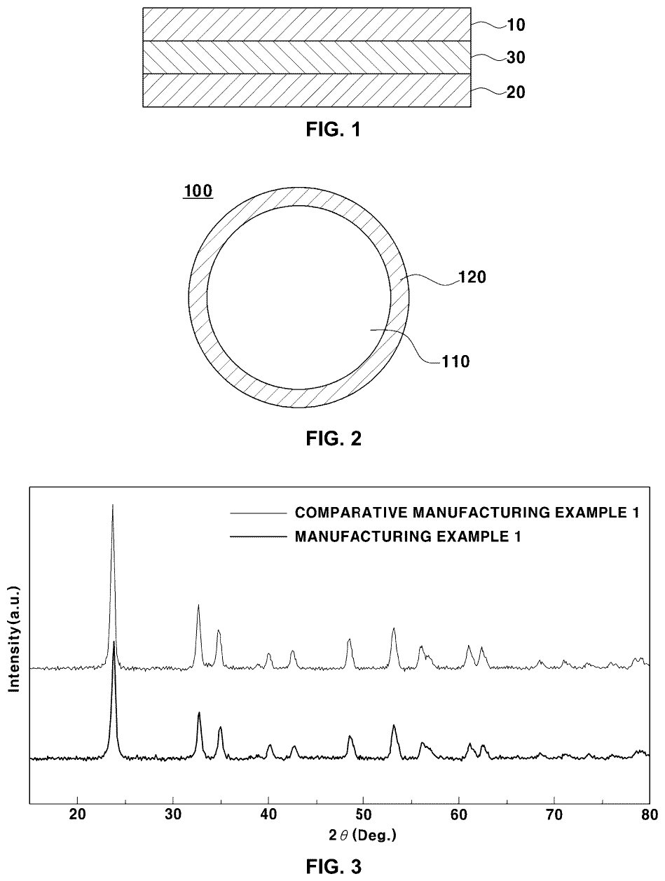

FIG. 1 shows a lithium secondary battery according to an embodiment of the present disclosure. The lithium secondary battery may include an all-solid-state battery. The lithium secondary battery may include a cathode 10, an anode 20, and a solid electrolyte layer 30 disposed between the cathode 10 and the anode 20.

The cathode 10 may include a composite cathode active material, a first solid electrolyte, a first conductive material, a first binder, and the like.

FIG. 2 shows a composite cathode active material 100 according to an embodiment of the present disclosure. The composite cathode active material 100 may include a core part 110 and a shell part 120 configured to cover surfaces of the core part 110.

The core part 110 may include a lithium transition metal oxide configured to enable intercalation and deintercalation of lithium.

The lithium transition metal oxide may include any lithium transition metal oxide generally used in the technical field to which the present disclosure belongs. For example, the lithium transition metal oxide may include LiNiₓ₁Coₓ₂Mnₓ₃O₂ (0.65≤x1≤0.85, 0.05≤x2≤0.25, 0.03≤x3≤0.2, and x1+x2+x3=1).

The core part 110 may be in the form of secondary particles formed by agglomeration of primary particles including the lithium transition metal oxide. The primary particle is the minimum particle unit which is distinguished as one lump when the cross-sections of the core part 110 are observed through equipment, such as a scanning electron microscope (SEM). The primary particle may be formed by one grain or may be formed by a plurality of grains. The secondary particle may indicate a structure formed by agglomeration of a plurality of primary particles. The secondary particles are not limited to a specific shape and may have, for example, a spherical shape or an oval shape.

The average particle diameter D50 of the core part 110 is not limited to a specific value and may be, for example, 1 μm to 20 μm. The average particle diameter D50 of the core part 110 may be measured using a laser diffraction particle size distribution measurer which is currently on the market, for example, a Microtrac™ particle size distribution measurement apparatus. Otherwise, 200 particles may be extracted from an electron microscope image, and the average particle diameter of the particles may be calculated.

The shell part 120 may include an alkali metal oxide.

The alkali metal oxide may include an alkali metal, a transition metal, and a substituent element. The substituent element may include an element which is substituted for a part of the alkali metal and has a greater oxidation number than the alkali metal.

The alkali metal may transmit lithium ions discharged from the core part 110 at the interfaces between the first solid electrolyte and the shell part 120 and the interfaces between the shell part 120 and the core part 110 in the cathode 10.

The alkali metal may include at least one element selected from the group consisting of lithium (Li), sodium (Na), potassium (K), and combinations thereof. Preferably, the alkali metal may include lithium (Li).

In embodiments of the present disclosure, the substituent element having a greater oxidation number than the alkali metal is substituted for the alkali metal, and thus, vacancies configured to maintain electrical neutrality of the alkali metal oxide may be formed. Thereby, lithium ion conductivity of the shell part 120 may be increased.

The substituent element may include a non-transition metal having a fixed oxidation number. Here, fixation of an oxidation number may mean that, when the substituent element forms a compound with specific elements, the oxidation number of the substituent element is not changed. For example, the substituent element may indicate an element which reacts with specific elements, such as lithium, with a fixed oxidation number, although there may theoretically be a plurality of oxidation numbers of the element. Because the substituent element has the fixed oxidation number, the ionic radius of the substituent element is not deformed beyond the fixed oxidation number range, unlike transition metals.

The substituent element may be substituted for the sites of the alkali metal. There were many conventional attempts to substitute and/or dope a compound forming a coating layer of a cathode active material with various elements, but these attempts differ from the embodiments of the present disclosure in that a target for substitution and/or doping is not an alkali metal but a transition metal.

Instruction sites of the substituent element may be adjusted by properly changing the kinds of raw materials of the alkali metal oxide and the composition of the raw materials.

The substituent element may be substituted for the sites of the alkali metal, may strongly bond to other elements in a crystal structure without reacting with surrounding elements during the operating process of the lithium secondary battery, and may thus increase physicochemical stability of the shell part 120. Thereby, stability of the interfaces between the first solid electrolyte and the shell part 120 and the interfaces between the shell part 120 and the core part 110 may be improved. Further, side reaction by the shell part 120 does not occur, and thus, electrochemical characteristics of the lithium secondary battery may be improved.

The substituent element may stabilize oxygen in the alkali metal oxide during a process of charging and discharging the lithium secondary battery. O¹⁻ generated due to oxidation-reduction reaction of oxyanions thermodynamically tend to reduce coordination with surrounding cations so as to be stabilized. The substituent element may effectively stabilize oxygen without deforming a bonding structure between the alkali metal and oxygen. The substituent element may prevent oxygen from leaking or being lost from the alkali metal oxide, thus being capable of greatly increasing stability of the shell part 120.

The substituent element may include any non-transition metal having a fixed oxidation number which is greater than the alkali metal, preferably at least one element selected from the group consisting of magnesium (Mg), aluminum (Al), gallium (Ga), silicon (Si), germanium (Ge), tin (Sn), antimony (Sb), arsenic (As), and combinations thereof. More preferably, the substituent element may include magnesium (Mg).

The transition metal may include any transition metal included in an alkali metal oxide which is generally used in the technical field to which the present disclosure belongs. For example, the transition metal may include at least one element selected from the group consisting of niobium (Nb), tantalum (Ta), zirconium (Zr), and combinations thereof.

However, the alkali metal oxide may further include a non-metallic element together with the transition metal. The non-metallic element is not limited to a specific non-metallic element, and it may include, for example, at least one element selected from the group consisting of boron (B), phosphorous (P), and combinations thereof.

The alkali metal oxide may include a compound represented by Chemical Formula 1 below.

(A₁₋ₐₓBₓ)MO₃ Chemical Formula 1

In Chemical Formula 1, A may include the alkali metal.
B may include at least one element selected from the group consisting of magnesium (Mg), aluminum (Al), gallium (Ga), silicon (Si), germanium (Ge), tin (Sn), antimony (Sb), arsenic (As), and combinations thereof.
M may include at least one element selected from the group consisting of niobium (Nb), tantalum (Ta), boron (B), zirconium (Zr), phosphorous (P), and combinations thereof.
a may indicate the oxidation number of B.
x may satisfy 0.01≤x≤0.3.

When x is less than 0.01, an effect of increasing physicochemical stability of the shell part 120 may not be obtained, and when x exceeds 0.3, the number of moles of the alkali metal is reduced beyond necessity, and thus lithium ions may not be smoothly conducted in the shell part 120.

The alkali metal oxide may include a compound represented by Chemical Formula 2 below.

[(A₁₋ₐₓ(B1₁₋ₘB2ₘ)ₓ](M1₁₋ₙM2ₙ)O₃ Chemical Formula 2

In Chemical Formula 2, A may include the alkali metal.

B1 and B2 may be different from each other and may independently include at least one element selected from the group consisting of magnesium (Mg), aluminum (Al), gallium (Ga), silicon (Si), germanium (Ge), tin (Sn), antimony (Sb), arsenic (As), and combinations thereof.

M1 and M2 may be different from each other and may independently include at least one element selected from the group consisting of niobium (Nb), tantalum (Ta), boron (B), zirconium (Zr), phosphorous (P), and combinations thereof.

The oxidation numbers of B1 and B2 may be the same.
a may indicate the oxidation number of B1 or B2.
m, n, and x may satisfy 0≤m≤1, 0≤n≤1 and 0.01≤x≤0.3.

The composite cathode active material 100 may include 98 wt % to 99.9 wt % of the core part 110 and 0.1 wt % to 2 wt % of the shell part 120. When the content of the shell part 120 is less than 0.1 wt %, the effect of introducing the shell part 120 may not be obtained, and when the content of the shell part 120 exceeds 2 wt %, the thickness of the shell part 120 is increased and may thus hinder conduction of lithium ions. Further, when the shell part 120 includes the alkali metal oxide represented by Chemical Formula 1 and/or Chemical Formula 2 as in embodiments of the present disclosure, the shell part 120 may be formed as a conformal layer, and thereby, the shell part 120 having high uniformity and coverage may be obtained even with a small amount of 2 wt % or less of the shell part 120. This will be described below.

The composite cathode active material 100 may be manufactured through various methods, such as a liquid-state method, a solid-state method, and the like, without being limited to a specific method.

The liquid-state method may include preparing the core part, preparing the raw materials of the alkali metal oxide, acquiring an intermediate by putting the core part and the raw materials into a solvent and agitating the core part and the raw materials in the solvent, drying the intermediate, and heat-treating the dried intermediate.

The raw materials may include alkoxides of the alkali metal, the transition metal (and/or the non-metallic element), and the substituent element. For example, the raw materials may include lithium ethoxide, niobium ethoxide, magnesium ethoxide, and the like.

The substituent element may be substituted for the alkali metal rather than the transition metal so as to occupy the sites of the alkali metal by adjusting the kinds and contents of components of the raw materials and the ratio of the components and the like.

The solvent is not limited to a specific kind, and it may include an organic solvent, such as alcohol, an aqueous solvent, or the like.

The solid-state method may include preparing the raw materials of the alkali metal oxide, acquiring a ground material by grinding the raw materials using a ball mill, acquiring the alkali metal oxide by heat-treating the ground material, and forming the shell part including the alkali metal oxide on the surfaces of the core part.

The raw materials may include oxides of the alkali metal, the transition metal (and/or the non-metallic element), and the substituent element. For example, the raw materials may include lithium carbonate, niobium oxide, magnesium oxide, and the like.

In acquiring the ground material, the raw materials may be ground by a high energy ball milling method. The high energy ball milling method is not limited to a specific execution method, apparatus, conditions, or the like, and it may use high energy planetary ball mill equipment which may be revolved and rotated at a high speed.

The first solid electrolyte may be in charge of conduction of lithium ions in the cathode 10.

The first solid electrolyte may include at least one electrolyte selected from the group consisting of an oxide-based solid electrolyte, a sulfide-based solid electrolyte, and combinations thereof. Further, the first solid electrolyte may be crystalline, amorphous, or a mixed state thereof.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ(m and n being positive numbers and Z being one of Ge, Zn, and Ga), Li₂S—GeS₂, Li₂S—SiS₂—Li₃PO₄, Li₂S—SiS₂-LiₓMO_{y} (x and y being positive numbers and M being one of P, Si, Ge, B, Al, Ga and In), Li₁₀GeP₂S₁₂, or the like, without being limited to a specific material.

Preferably, the first solid electrolyte may include a sulfide-based inorganic electrolyte having an argyrodite-type crystal structure. The sulfide-based inorganic electrolyte having the argyrodite-type crystal structure may include at least one selected from the group consisting of Li_{7-y}PS_{6-y}Ha_{y} (Ha including Cl, Br, or I, and 0<y≤2), Li_{7-z}PS_{6-z} (Ha1_{1-b}Ha2_{b})_{z} (Ha1 and Ha2 being different and independently including Cl, Br, or I, 0<b<1, and 0<z≤2), and combinations thereof.

The first conductive material may include carbon black, conductive graphite, ethylene black, graphene, carbon nanotubes, carbon nanofibers, vapor grown carbon fibers, or the like.

The first binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like. The first binder may be present in a particulate type, a linear type, or the like in the cathode 10.

The cathode 10 may include 70 wt % to 90 wt % of the composite cathode active material, 10 wt % to 15 wt % of the first solid electrolyte, 1 wt % to 5 wt % of the first conductive material, and 1 wt % to 5 wt % of the first binder. However, the contents of the respective components may be properly adjusted in consideration of desired capacity, efficiency, and the like of the all-solid-state battery.

The thickness of the cathode 10 may be 1 μm to 100 μm, without being limited to a specific value. The thickness of the cathode 10 may mean the average value of measured thicknesses of five measurement targets. Further, the thickness of the cathode 10 may indicate the thickness of the cathode 10 when the lithium secondary battery is discharged.

According to a first embodiment of the present disclosure, the anode 20 may be a composite anode including an anode active material, a second solid electrolyte, a second conductive material, a second binder, and the like.

The anode active material may be, for example, a carbon active material or a metal active material, without being limited to a specific active material.

The carbon active material may be mesocarbon microbeads (MCMBs), graphite such as highly oriented pyrolytic graphite (HOPG), or amorphous carbon such as hard carbon or soft carbon.

The metal active material may be indium (In), aluminum (Al), silicon (Si), tin (Sn), an alloy including at least one of these elements, or the like.

The anode active material may be a composite of a carbon active material and a metal active material. For example, the anode active material may be a carbon active material configured such that the surface thereof is coated with a metal active material and a metal active material configured such that the surface thereof is coated with a carbon active material.

The second solid electrolyte may be in charge of conduction of lithium ions in the anode 20.

The second solid electrolyte may include at least one electrolyte selected from the group consisting of an oxide-based solid electrolyte, a sulfide-based solid electrolyte, and combinations thereof. Further, the second solid electrolyte may be crystalline, amorphous, or a mixed state thereof.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn, and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga, and In), Li₁₀GeP₂S₁₂, or the like, without being limited to a specific material.

Preferably, the second solid electrolyte may include a sulfide-based inorganic electrolyte having an argyrodite-type crystal structure. The sulfide-based inorganic electrolyte having the argyrodite-type crystal structure may include at least one material selected from the group consisting of Li_{7-y}PS_{6-y}Ha_{y} (Ha including Cl, Br, or I, and 0<y≤2), Li_{7-z}PS_{6-z} (Ha1_{1-b}Ha2_{b})_{z} (Ha1 and Ha2 being different and independently including Cl, Br, or I, 0<b<1, and 0<z≤2), and combinations thereof.

The second solid electrolyte may be the same as or different from the first solid electrolyte.

The second conductive material may include carbon black, conductive graphite, ethylene black, graphene, carbon nanotubes, carbon nanofibers, vapor grown carbon fibers, or the like.

The second conductive material may be the same as or different from the first conductive material.

The second binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like. The first binder may be present in a particulate type, a linear type, or the like in the anode 20.

The second binder may be the same as or different from the first binder.

The anode 20 may include 80 wt % to 85 wt % of the anode active material, 10 wt % to 15 wt % of the second solid electrolyte, and 1 wt % to 5 wt % of the second binder. However, the contents of the respective components may be properly adjusted in consideration of desired capacity, efficiency, and the like of the all-solid-state battery.

The thickness of the anode 20 may be 1 μm to 100 μm, without being limited to a specific value. The thickness of the anode 20 may mean the average value of measured thicknesses of five measurement targets. Further, the thickness of the anode 20 may indicate the thickness of the anode 20 when the lithium secondary battery is discharged.

According to a second embodiment of the present disclosure, the anode 20 may include lithium metal or a lithium metal alloy.

The lithium metal alloy may include an alloy of lithium and a metal or a metalloid which is alloyable with lithium. The metal or the metalloid which is alloyable with lithium may include silicon (Si), tin (Sn), aluminum (Al), germanium (Ge), lead (Pb), bismuth (Bi), antimony (Sb), or the like.

According to a third embodiment of the present disclosure, the anode 20 may not include an anode active material and an element having substantially the same function as the anode active material. When the all-solid-state battery is charged, lithium ions discharged from the cathode 10 are deposited and stored in the form of lithium metal between the anode 20 and an anode current collector (not shown).

The anode 20 may include amorphous carbon and a metal which is alloyable with lithium.

The amorphous carbon may include at least one material selected from the group consisting of furnace black, acetylene black, Ketjen black, graphene, and combinations thereof.

The metal may include at least one metal selected from the group consisting of gold (Au), platinum (Pt), palladium (Pd), silicon (Si), silver (Ag), aluminum (Al), bismuth (Bi), tin (Sn), zinc (Zn), and combinations thereof.

The anode 20 may include 90 wt % to 99 wt % of the amorphous carbon and 1 wt % to 10 wt % of the metal. However, the contents of the respective components may be properly adjusted in consideration of desired capacity, efficiency, and the like of the all-solid-state battery.

The solid electrolyte layer 30 may be provided in a sheet type having at least two main surfaces facing each other. The two main surfaces may respectively include mathematically flat surfaces, may include curved surfaces in some areas, or may have irregularities caused by manufacture of the solid electrolyte layer 30. In this regard, the sheet type is not limited to a relatively thin rectangular parallelepiped layer.

In the sheet-type solid electrolyte layer 30, a distance between the two main surfaces facing each other may be the thickness of the solid electrolyte layer 30. The length of a first direction (for example, a width direction) perpendicular to a thickness direction of the solid electrolyte layer 30 is greater than the thickness of the solid electrolyte layer 30. Further, the length of a second direction (for example, a length direction) perpendicular to the thickness direction and the first direction of the solid electrolyte layer 30 is greater than the thickness of the solid electrolyte layer 30.

The thickness of the solid electrolyte layer 30 may be 1 μm to 100 μm, without being limited to a specific value. The thickness of the solid electrolyte layer 30 may mean the average value of measured thicknesses of five measurement targets.

The solid electrolyte layer 30 may include a third solid electrolyte having lithium ion conductivity, a third binder, and the like.

The third solid electrolyte may include at least one electrolyte selected from the group consisting of an oxide-based solid electrolyte, a sulfide-based solid electrolyte, and combinations thereof. Further, the third solid electrolyte may be crystalline, amorphous, or a mixed state thereof.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn, and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga, and In), Li₁₀GeP₂S₁₂, or the like, without being limited to a specific material.

Preferably, the third solid electrolyte may include a sulfide-based inorganic electrolyte having an argyrodite-type crystal structure. The sulfide-based inorganic electrolyte having the argyrodite-type crystal structure may include at least one material selected from the group consisting of Li_{7-y}PS_{6-y}Ha_{y} (Ha including Cl, Br, or I, and 0<y≤2), Li_{7-z}PS_{6-z} (Ha1_{1-b}Ha2_{b})_{z} (Ha1 and Ha2 being different and independently including Cl, Br, or I, 0<b<1, and 0<z≤2), and combinations thereof.

The third solid electrolyte may be the same as or different from the first solid electrolyte and the second solid electrolyte.

The third binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like. The first binder may be present in a particulate, a linear type, or the like in the solid electrolyte layer 30.

The third binder may be the same as or different from the first binder and the second binder.

Hereinafter, embodiments of the present disclosure will be described in more detail through the following Examples and Comparative Examples. The following Examples and Comparative Examples serve merely to exemplarily describe embodiments of the present disclosure, and they are not intended to limit the scope and spirit of the invention.

### Manufacturing Example 1

An alkali metal oxide expressed as Li_{0.9}Mg_{0.05}NbO₃ was manufactured as below.

Lithium ethoxide, niobium ethoxide, and magnesium ethoxide as raw materials were weighed and prepared depending on the composition of the alkali metal oxide.

An intermediate was acquired by putting the raw materials into anhydrous ethyl alcohol as a solvent and agitating the raw materials in the solvent at a temperature of about 70° C. and a rotational speed of about 300 rpm.

The intermediate was dried at a temperature of about 80° C. for about 12 hours using a vacuum oven.

The dried intermediate was put into a box furnace. The alkali metal oxide was acquired by raising the temperature of the box furnace to a temperature of about 300° C. at a rate of about 2° C./min while injecting oxygen gas into the box furnace at a flow rate of about 0.5 l/min, and then heat-treating the dried intermediate for about 5 hours.

### Comparative Manufacturing Example 1

An alkali metal oxide expressed as LiNbO₃ was manufactured in the same manner as in Manufacturing Example 1 except that raw materials were prepared to manufacture the alkali metal oxide expressed as LiNbO₃. Concretely, lithium ethoxide and niobium ethoxide as the raw materials were weighed and prepared depending on the composition of the alkali metal oxide LiNbO₃ and were agitated, dried, and heat-treated in the same manner as Manufacturing Example 1.

FIG. 3 shows X-ray diffraction analysis results of the alkali metal oxides according to Manufacturing Example 1 and Comparative Manufacturing Example 1. Referring to this figure, it may be confirmed that the alkali metal oxide according to Manufacturing Example 1 maintains the same crystal structure as the alkali metal oxide according to Comparative Manufacturing Example 1, although magnesium as a substituent element is substituted for lithium as an alkali metal. Further, it may be confirmed that the alkali metal oxide according to Manufacturing Example 1 has the crystal structure of a trigonal crystal structure and belongs to the R3c space group.

Rietveld analysis was performed so as to check the crystal structures of the alkali metal oxides according to Manufacturing Example 1 and Comparative Manufacturing Example 1 based on the X-ray diffraction analysis results of the respective compounds.

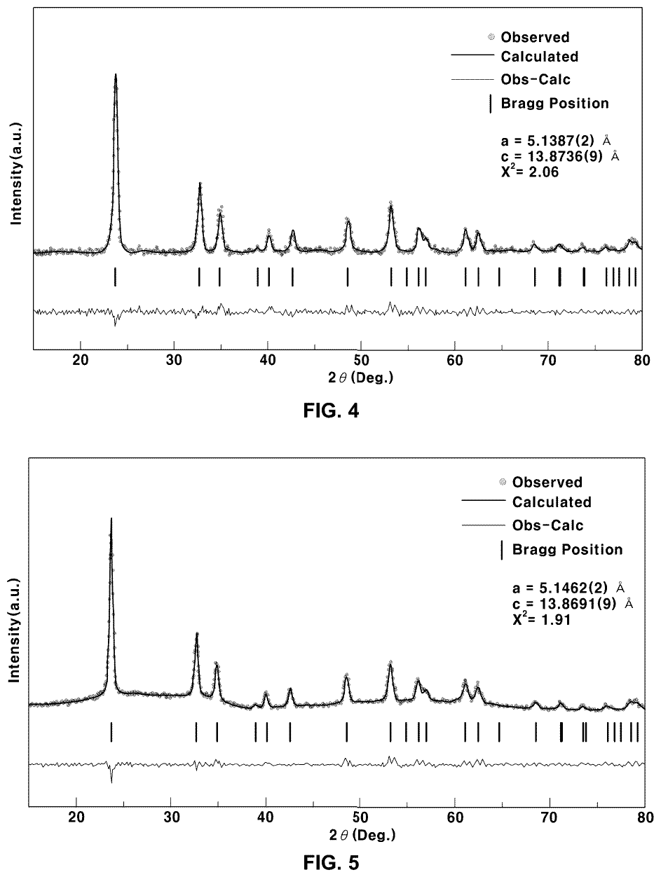

FIG. 4 shows Rietveld analysis results of the alkali metal oxide according to Manufacturing Example 1. FIG. 5 shows Rietveld analysis results of the alkali metal oxide according to Comparative Manufacturing Example 1. The results of FIGS. 4 and 5 tend to coincide with the X-ray diffraction analysis results of FIG. 3.

The results of FIG. 4 are set forth in Table 1 below. The results of FIG. 5 are set forth in Table 2 below.

TABLE 1

| | | Wyckoff | | | | | |
|---|---|---|---|---|---|---|---|
| Position | Atom | position | x | y | z | B_{ISO} | Occupancy |
| Li site | Li1 | 6a | 0 | 0 | 0.283(3) | 0.3(10) | 0.9 |
| | Mg1 | 6a | 0 | 0 | 0.283(3) | 0.3(10) | 0.055(10) |
| Nb | Nb1 | 6a | 0 | 0 | 0 | 0.48(5) | 0.997(2) |
| site | Mg2 | 6a | 0 | 0 | 0 | 0.48(5) | 0.000(9) |
| O site | O1 | 18b | 0.0402(14) | 0.350(3) | 0.074(2) | 0.3(2) | 1.000(14) |

TABLE 2

| | | Wyckoff | | | | | |
|---|---|---|---|---|---|---|---|
| Position | Atom | position | x | y | z | B_{ISO} | Occupancy |
| Li site | Li1 | 6a | 0 | 0 | 0.279(3) | 0.6(12) | 1 |
| Nb | Nb1 | 6a | 0 | 0 | 0 | 0.49(4) | 0.991(2) |
| site | | | | | | | |
| O site | O1 | 18b | 0.0426(12) | 0.346(2) | 0.0704(14) | 0.3(2) | 1.000(13) |

In Tables 1 and 2, parentheses to the right of each figure may indicate a standard deviation.

Referring to Table 1, in the alkali metal oxide according to Manufacturing Example 1, Li as the alkali metal and Mg as the substituent element occupy the sites of a Wyckoff position 6a (0,0,0.283) together. The occupancy of the Wyckoff position 6a (0,0,0283) by the alkali metal is about 90%, and the occupancy of Wyckoff position 6a (0,0,0283) by the substituent element is about 5.5%.

Meanwhile, in the alkali metal oxide according to Manufacturing Example 1, Mg as the substituent element does not occupy the sites of a Wyckoff position 6a (0,0,0). This may be shown by the fact that the occupancy of the Wyckoff position 6a (0,0,0) by Mg2 is 0% in Table 1.

It may be confirmed from the above results that Mg as the substituent element is not substituted for Nb as the transition metal but is substituted for Li as the alkali metal.

The unit cell volumes and the like of the alkali metal oxides according to Manufacturing Example 1 and Comparative Manufacturing Example 1 were detected through Rietveld analysis and are set forth in Table 3 below.

TABLE 3

| | Manufacturing | Comp. Manufacturing |
|---|---|---|
| Category | Example 1 | Example 1 |
| Unit cell volume [Å³] | 318.09 | 317.27 |
| LiO₆ octahedral volume [Å³] | 12.0666 | 12.1063 |
| Length of axis a [Å] | 5.1387 | 5.1462 |
| Length of axis c [Å] | 13.8736 | 13.8691 |
| O—Li—O angle to axis a [°] | 71.134 | 71.3763 |
| O—Li—O angle to axis c[°] | 80.297 | 80.2660 |

The alkali metal oxide according to Manufacturing Example 1 in which the substituent element is substituted for the alkali metal has reduced unit cell volume and LiO₆ octahedral volume, compared to the alkali metal oxide according to Comparative Manufacturing Example 1 in which there is no substituent element. The reason for this is that the ionic radius of magnesium ions (Mg²⁺) is less than the ionic radius of lithium ions (Li⁺). Further, it may be confirmed that the alkali metal oxide according to Manufacturing Example 1 has a decreased length of the axis a of the unit cell and an increased length of the axis c of the unit cell, compared to the alkali metal oxide according to Comparative Manufacturing Example 1, due to an ionic radius difference between the alkali metal and the substituent element. Moreover, for the same reason, it may be confirmed that the alkali metal oxide according to Manufacturing Example 1 has a decreased O—Li—O angle to the axis a and an increased O—Li—O angle to the axis c, compared to the alkali metal oxide according to Comparative Manufacturing Example 1.

Depending on the decreased length of the axis a and the increased length of the axis c of the unit cell of the alkali metal oxide according to Manufacturing Example 1, peaks are shifted in the Rietveld analysis results. Concretely, at least one of a (hkl) diffraction peak (012), (104), (110), or (113) obtained through Rietveld analysis of the alkali metal oxide according to Manufacturing Example 1 may be shifted so as to form a high Bragg angle, compared to the alkali metal oxide according to Comparative Manufacturing Example 1. The Bragg angles of the respective diffraction peaks are set forth in Table 4 below.

TABLE 4

| | Bragg angle [2θ] in Manufacturing | Bragg angle [2θ] in Comp. |
|---|---|---|
| Hkl | Example 1 | Manufacturing Example 1 |
| (012) | 23.7344 | 23.7123 |
| (104) | 32.7075 | 32.6966 |
| (110) | 34.8906 | 34.8388 |
| (006) | 38.9172 | 38.9313 |
| (113) | 40.1144 | 40.0718 |

It may be confirmed that, because a ratio of a change (+0.03%) of the length of the axis c to a change (−0.14%) of the length of the axis a in the alkali metal oxides according to Manufacturing Example 1 and Comparative Manufacturing Example 1 is very small, all peaks other than the hkl peak (006), which is affected only by the change of the length of the axis c, are shifted to form high Bragg angles.

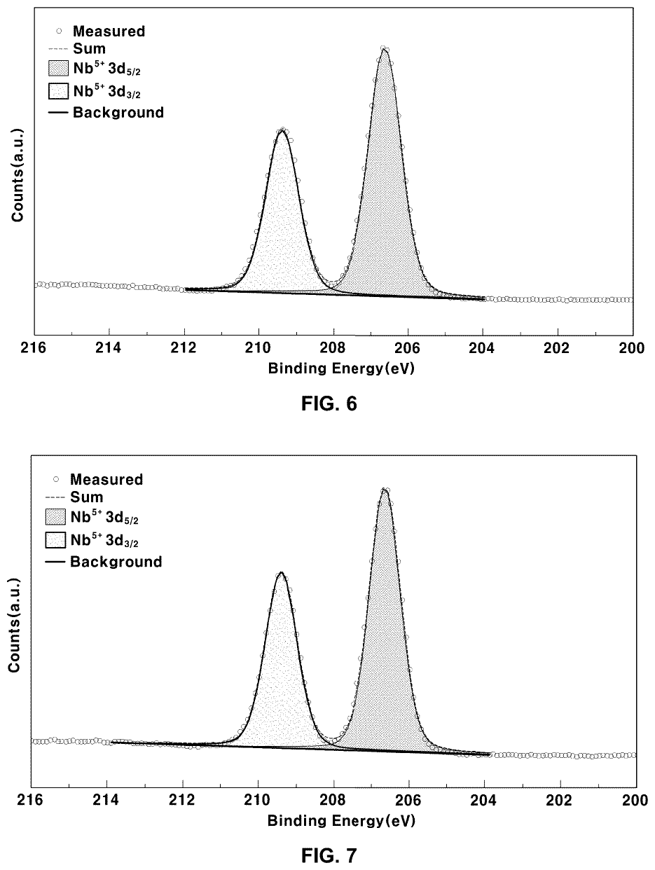

FIG. 6 shows X-ray photoelectron spectroscopy (XPS) analysis results of Nd 3d of the alkali metal oxide according to Manufacturing Example 1. FIG. 7 shows XPS analysis results of Nd 3d of the alkali metal oxide according to Comparative Manufacturing Example 1. It may be confirmed that, in view of no change in peaks shown in FIGS. 6 and 7, magnesium (Mg) as the substituent element does not influence niobium (Nb).

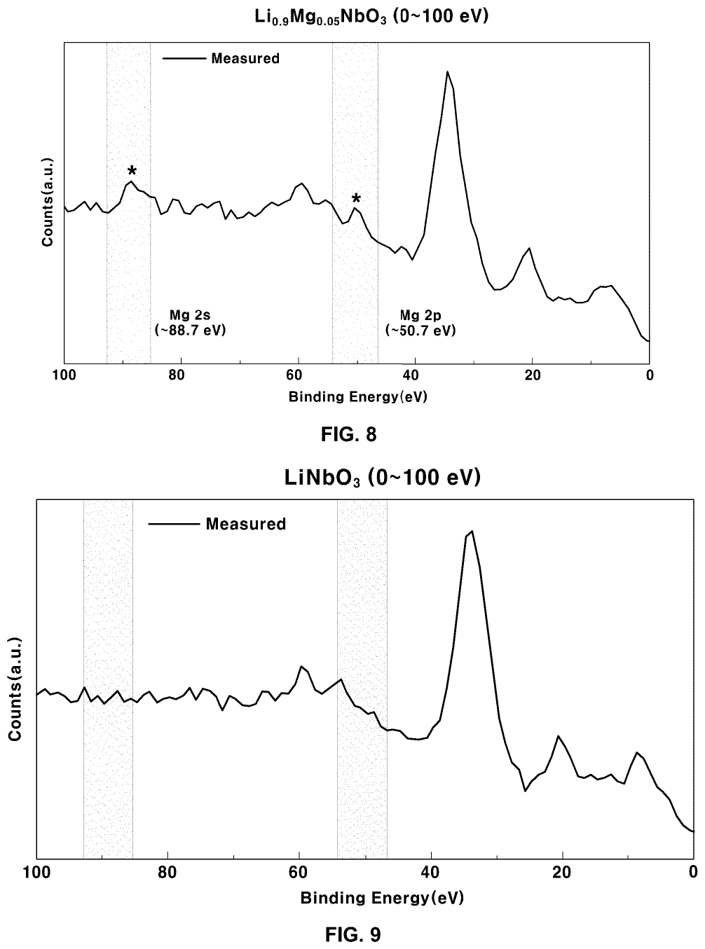

FIG. 8 shows XPS analysis results of the alkali metal oxide according to Manufacturing Example 1 in a binding energy range of 0-100 eV. FIG. 9 shows XPS analysis results of the alkali metal oxide according to Comparative Manufacturing Example 1 in the binding energy range of 0-100 eV. It may be confirmed that, considering that peaks caused by Mg 2s and Mg 2p are found, as shown in FIG. 8, the substituent element was well introduced into the alkali metal oxide according to Manufacturing Example 1.

Adsorption energy E_{ads} at each interface when magnesium (Mg) was substituted for the alkali metal of the alkali metal oxide was calculated through ab initio calculation. The adsorption energy E_{ads} was calculated using the Vienna Ab initio Simulation Package (VASP) program.

In the corresponding calculation, the adsorption energy E_{ads} at the interface was derived as: E_{ads}=E_{substrate@LMNO}−[E_{substrate}+E_{LMNO}].

Here, substrate means an adsorbent and may indicate the core part 110 or the solid electrolyte in embodiments of the present disclosure. LMNO may indicate the alkali metal oxide according to embodiments of the present disclosure. E_{substrate@LMNO} may indicate energy of a structure in which the alkali metal oxide is adsorbed onto the adsorbent, E_{substrate} may indicate energy of the surface structure of the adsorbent itself, and E_{LMNO} may indicate energy of the surface structure of the alkali metal oxide itself.

Adsorption energy of the alkali metal oxide to the core part was calculated while increasing the rate of magnesium (Mg) as the substituent element in the alkali metal oxide. A nickel-manganese-cobalt-based lithium oxide was used as the core part. Further, adsorption energy of the alkali metal oxide to the solid electrolyte was calculated while increasing the rate of magnesium (Mg) as the substituent element in the alkali metal oxide. Li₆P₅Cl_{0.5}Br_{0.5} was used as the solid electrolyte. Results of the adsorption energies are set forth in Table 5 below.

TABLE 5

| | | Adsorption energy |
|---|---|---|
| | | (−E_{ads}) |
| Adsorbent | Alkali metal oxide | [eV/nm] |
| Core | LiNbO₃ | −4.8302 |
| (NCM-based lithium oxide) | Li_{0.834}Mg_{0.083}NbO₃ | −4.8857 |
| | Li_{0.666}Mg_{0.167}NbO₃ | −5.0598 |
| Solid electrolyte | LiNbO₃ | −0.6334 |
| (Li₆PS₅Cl_{0.5}Br_{0.5}) | Li_{0.666}Mg_{0.167}NbO₃ | −1.0541 |
| | Li_{0.34}Mg_{0.33}NbO₃ | −0.4206 |

Referring to Table 5, it may be predicted that, considering that adsorption energy of the alkali metal oxide including the substituent element according to embodiments of the present disclosure to the core part and adsorption energy of the alkali metal oxide to the solid electrolyte have negative values, interfacial structures between the alkali metal oxide, the core part, and the solid electrolyte may be stably maintained. Further, it may be confirmed that, considering that the absolute value of the adsorption energy of the alkali metal oxide to the core part is increased as the rate of the substituent element is increased, introduction of the substituent element may greatly facilitate increase in interfacial stability. It may be confirmed, considering that the adsorption energy of the alkali metal oxide to the solid electrolyte is reduced when the number of moles of the substituent element exceeds 0.3, a proper amount of the substituent element should be introduced.

Activation barrier energy which is a factor influencing conduction of lithium ions in the alkali metal oxide was calculated through ab initio calculation. In this calculation, the activation barrier energy of a structure was derived using the nudged elastic band (NEB) method, and the calculation was performed after 5 intermediate phases between respective sites were formed. Calculation results of activation barrier energies are set forth in Table 6 below.

TABLE 6

| Category | Activation barrier energy [meV] |
|---|---|
| LiNbO₃ | 1091.30 |
| Li_{0.666}Mg_{0.167}NbO₃ | 1038.78 |
| Li_{0.5}Mg_{0.25}NbO₃ | 1038.79 |
| Li_{0.34}Mg_{0.33}NbO₃ | 1038.38 |

Referring to FIG. 6, the activation barrier energy tends to be lowered as the substituent element is introduced. Therefore, the alkali metal oxide according to embodiments of the present disclosure may have higher lithium ion conductivity than the alkali metal oxide including no substituent element.

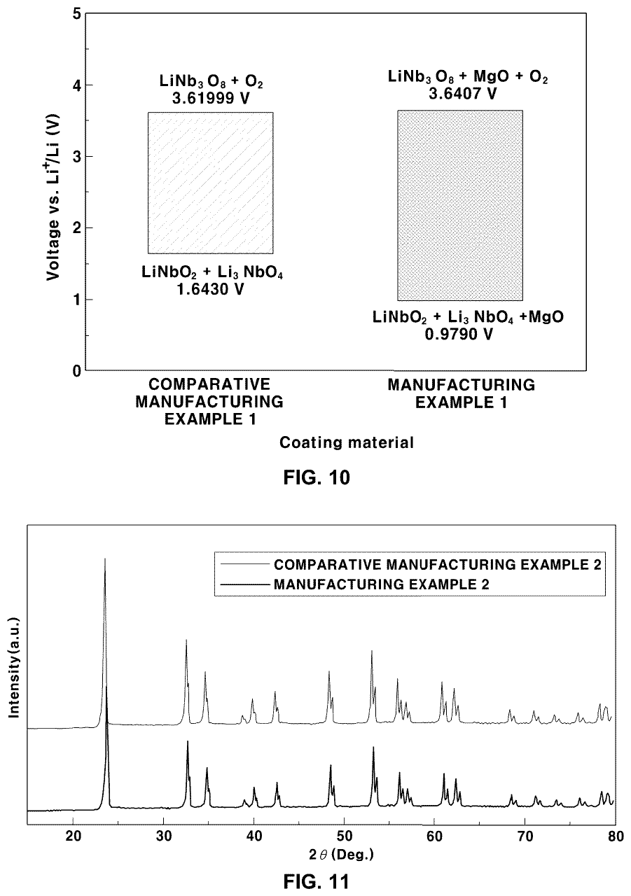

FIG. 10 shows calculation results of stable potential windows of the alkali metal oxides according to Manufacturing Example 1 and Comparative Manufacturing Example 1.

The respective alkali metal oxides are decomposed into a lithium niobium oxide and oxygen in a high-voltage area. However, the alkali metal oxides are decomposed into lithium niobium oxides having different compositions in a low-voltage area, and it is expected that magnesium oxide is additionally formed due to the presence of the substituent element in Manufacturing Example 1. Energies of respective decomposition products were calculated based on this prediction and are shown in FIG. 10.

As results, the alkali metal oxide according to Manufacturing Example 1 exhibits a wide potential window, compared to the alkali metal oxide according to Comparative Manufacturing Example 1, and particularly, exhibits greatly increased stability at a low voltage. It may be predicted that the alkali metal oxide according to embodiments of the present disclosure exhibits improved interfacial stability in the low-voltage area, i.e., in a state in which the concentration of lithium in the cathode is low, through these potential window characteristics.

### Manufacturing Example 2

An alkali metal oxide expressed as Li_{0.9}Mg_{0.05}NbO₃ was manufactured through the liquid-state method.

Lithium carbonate (Li₂CO₃), niobium oxide (Nb₂O₅), and magnesium oxide (MgO) as raw materials were weighed and prepared depending on the composition of the alkali metal oxide.

A ground material was obtained by putting the raw materials into high energy ball mill equipment in an argon (Ar) gas atmosphere and grinding the raw materials at about 400 rpm for about 12 hours.

The ground material was put into a box furnace. The alkali metal oxide was acquired by raising the temperature of the box furnace to a temperature of about 850° C. at a rate of about 2° C./min while injecting oxygen gas into the box furnace at a flow rate of about 0.3 l/min, and then heat-treating the ground material for about 5 hours.

### Comparative Manufacturing Example 2

An alkali metal oxide expressed as LiNbO₃ was manufactured in the same manner as in Manufacturing Example 2 except that raw materials were prepared to manufacture the alkali metal oxide. Concretely, lithium carbonate (Li₂CO₃) and niobium oxide (Nb₂O₅) were weighed and prepared depending on the composition of the alkali metal oxide LiNbO₃ and were ground and heat-treated in the same manner as in Manufacturing Example 2.

FIG. 11 shows X-ray diffraction analysis results of the alkali metal oxides according to Manufacturing Example 2 and Comparative Manufacturing Example 2. Referring to this figure, it may be confirmed that the alkali metal oxide according to Manufacturing Example 2 maintains the same crystal structure as the alkali metal oxide according to Comparative Manufacturing Example 2, although Mg as the substituent element is substituted for Li as the alkali metal in the alkali metal oxide according to Manufacturing Example 2. Further, it may be confirmed that the substituent element is well introduced through the solid-state method rather than the liquid-state method.

### Manufacturing Example 3

A composite cathode active material including a core part and a shell part according to embodiments of the present disclosure was manufactured as below. The composition of an alkali metal oxide forming the shell part was Li_{0.9}Mg_{0.05}NbO₃.

Lithium ethoxide, niobium ethoxide, and magnesium ethoxide as raw materials were weighed and prepared depending on the composition of the alkali metal oxide.

An intermediate was acquired by putting the raw materials and the core part into anhydrous ethyl alcohol as a solvent and agitating the raw materials and the core part in the solvent at a temperature of about 70° C. and a rotational speed of about 300 rpm. A nickel-manganese-cobalt-based lithium oxide was used as the core part. Further, the contents of the raw materials and the core part were adjusted so that the composite cathode active material, i.e., a final product, includes 99 wt % of the core part and 1 wt % of the shell part with respect to the total weight of the composite cathode active material.

The intermediate was dried at a temperature of about 80° C. for about 12 hours using a vacuum oven.

The dried intermediate was put into a box furnace. The composite cathode active material was acquired by raising the temperature of the box furnace to a temperature of about 300° C. at a rate of about 2° C./min while injecting oxygen gas into the box furnace at a flow rate of about 0.5 l/min, and then heat-treating the dried intermediate for about 5 hours.

### Comparative Manufacturing Example 3

A composite cathode active material was manufactured in the same manner as in Manufacturing Example 3 except that raw materials were prepared so that the composition of an alkali metal oxide forming the shell part is LiNbO₃. Concretely, lithium ethoxide and niobium ethoxide as the raw materials were weighed and prepared depending on the composition of the alkali metal oxide LiNbO₃.

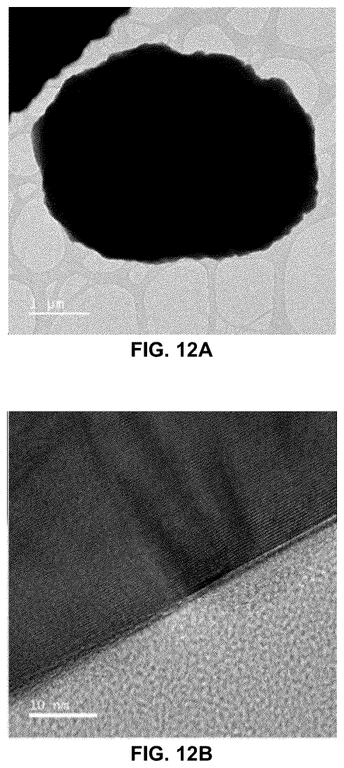

FIG. 12A shows high resolution transmission electron microscopy (HR-TEM) analysis results of the composite cathode active material according to Manufacturing Example 3. FIG. 12B shows HR-TEM analysis results acquired at a different magnification from that of FIG. 12A.

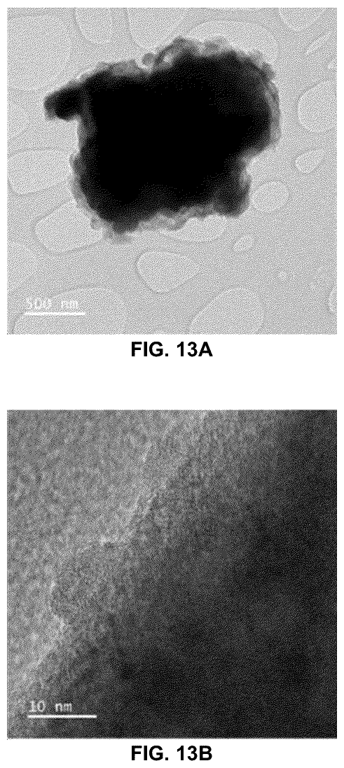

FIG. 13A shows HR-TEM analysis results of the composite cathode active material according to Comparative Manufacturing Example 3. FIG. 13B shows HR-TEM analysis results acquired at a different magnification from that of FIG. 13A.

Referring to FIG. 13A, the shell part of the composite cathode active material according to Comparative Manufacturing Example 3 is formed loosely and unevenly. On the contrary, referring to FIG. 12A, the shell part of the composite cathode active material according to Manufacturing Example 3 is formed very evenly and densely along the contours of the core part. This may be seen more clearly through comparison between FIGS. 12B and 13B. It may be confirmed that the shell part according to Manufacturing Example 3 is formed very uniformly and smoothly along the contours of the core part without irregularities or pinholes, as shown in FIG. 12B, but the shell part according to Comparative Manufacturing Example 3 has a rough surface and an uneven thickness regardless of the contours of the core part, as shown in FIG. 13B. Thereby, it may be confirmed that the shell part using the alkali metal oxide according to embodiments of the present disclosure may be formed as a conformal layer. Here, the conformal layer may indicate a series of layers coinciding with the contour of a coated material. Further, the conformal layer may indicate a layered structure having excellent conformity, a uniform thickness, and high coverage to a coated material.

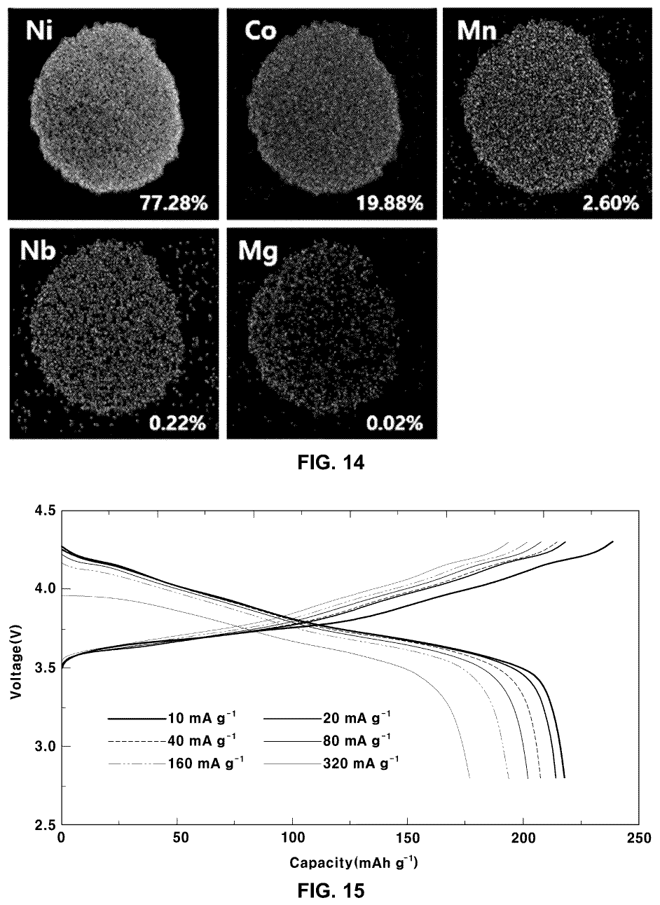

FIG. 14 shows HR-TEM-energy dispersive spectroscopy (HR-TEM-EDS) analysis results of the composite cathode active material according to Comparative Manufacturing Example 3. It may be confirmed that, comparing proportions of respective elements of the composite cathode active material, Mg is well introduced into the shell part, and Mg is uniformly distributed on the surface of the composite cathode active material.

### Example 1

A lithium ion battery using the composite cathode active material according to Manufacturing Example 3 was manufactured as below.

A slurry was manufactured by preparing the composite cathode active material, a conductive material, and a binder in a weight ratio of 80:5:15 and putting the prepared composite cathode active material, conductive material, and binder into N-methyl-2-pyrrolidone as a solvent. A cathode was manufactured by applying the slurry to a base substrate and drying the slurry. Super-P was used as the conductive material, and polyvinylidene fluoride was used as the binder.

A structure was manufactured by stacking the cathode on one surface of a separator including glass fibers and attaching lithium foil to the other surface of the separator. The lithium ion battery was manufactured by injecting a liquid electrolyte into the structure. Here, the liquid electrolyte was obtained by dissolving a lithium salt LiPF₆ in an electrolyte, including ethyl carbonate, ethyl methyl carbonate, and dimethyl carbonate in a volume ratio of 2:4:4, at a concentration of about 1.15 M.

### Comparative Example 1

A lithium ion battery was manufactured in the same manner as in Example 1 except that the composite cathode active material according to Comparative Manufacturing Example 3 was used.

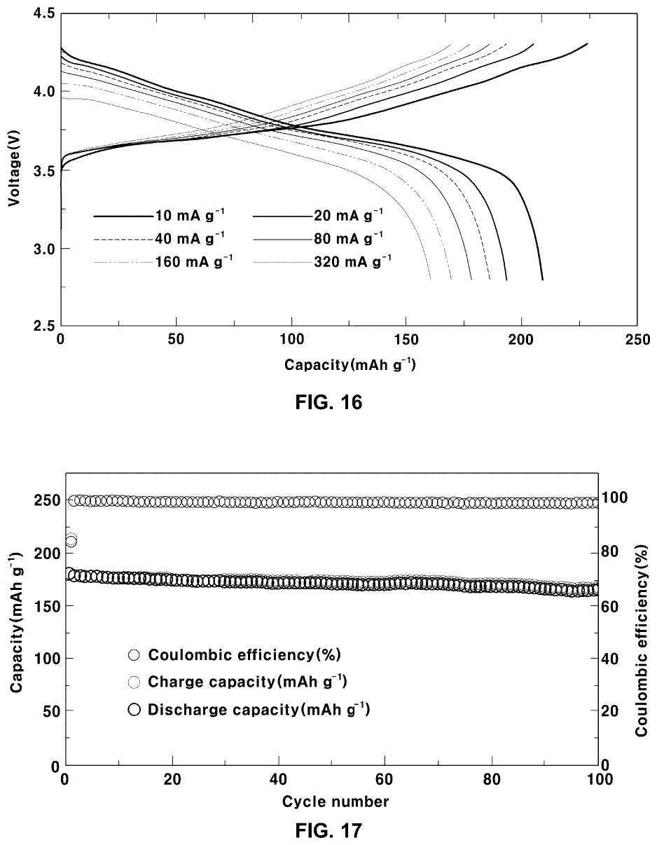

FIG. 15 shows C-rate test results of the lithium ion battery according to Example 1. FIG. 16 shows C-rate test results of the lithium ion battery according to Comparative Example 1. The lithium ion battery according to Example 1 exhibits capacity of 217.4 mAh/g and the lithium ion battery according to Comparative Example 1 exhibits capacity of 208.9 mAh/g at a current density of 10 mA/g. These results mean that interfacial resistance at the interfaces between the core part and the shell part is relieved through introduction of the substituent element. Further, the lithium ion batteries according to Example 1 and Comparative Example 1 respectively exhibit capacities of 176. 5 mAh/g and 160.8 mAh/g at a current density of 320 mA/g, and thereby, it may be confirmed that the lithium ion battery according to Example 1 shows the interfacial resistance relief effect even at a high current density.

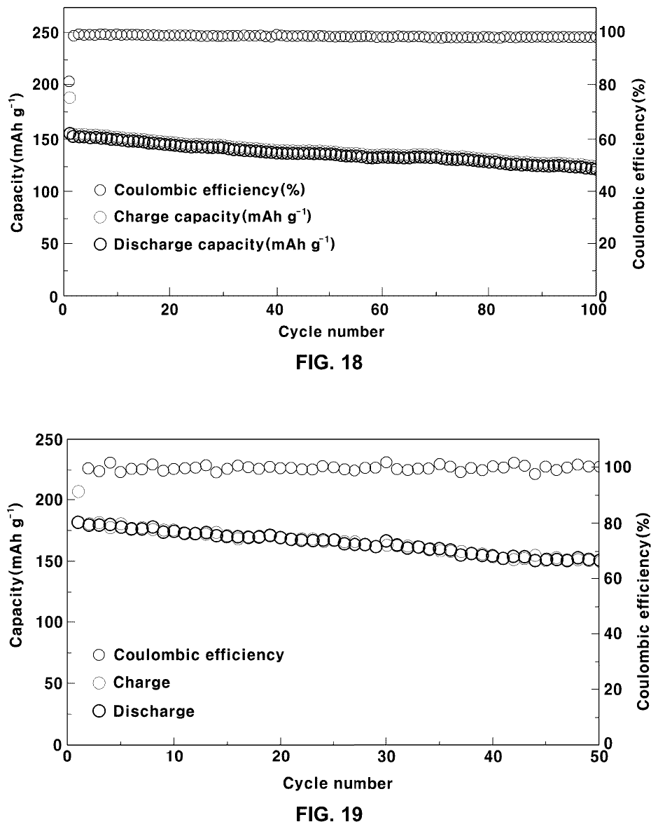

FIG. 17 shows measurement results of cycle life and Columbic efficiency of the lithium ion battery according to Example 1. FIG. 18 shows measurement results of cycle life and Columbic efficiency of the lithium ion battery according to Comparative Example 1. As a result of execution of 100 charge cycles at a current density of 200 mA/g, the lithium ion batteries according to Example 1 and Comparative Example 1 exhibit capacity retentions of 92.6% and 79.4%, respectively. Thereby, it may be confirmed that long-term stability of the composite cathode active material is increased through introduction of a proper amount of the substituent element.

### Example 2

An all-solid-state battery using the composite cathode active material according to Manufacturing Example 3 was manufactured as below.

The composite cathode active material and a first solid electrolyte were prepared in a weight ratio of 70:30, and 1 wt part of a first binder with respect to 100 wt parts of the composite cathode active material and the first solid electrolyte was prepared. The first solid electrolyte is a sulfide-based solid electrolyte expressed as Li₆PS₅Cl. The first binder is nitrile butadiene rubber.

The composite cathode active material and the first solid electrolyte were mixed with mixing balls and were then agitated at about 1,500 rpm for about 5 minutes. The binder was put into the composite cathode active material and the first solid electrolyte, and the composite cathode active material, the first solid electrolyte, and the binder were agitated at about 1,500 rpm for about 2 minutes. After the mixing balls were removed, the composite cathode active material, the first solid electrolyte, and the binder were mixed at about 1,500 rpm for about 1 minute. Cathode powder was obtained by putting an obtained result into a vacuum oven and drying the result at a temperature of about 60° C. for about 24 hours.

A stack of a cathode and a solid electrolyte layer was obtained by putting the cathode powder into a mold so that the loading amount of the composite cathode active material became about 10.5 mg/cm², putting about 120 mg of pellets formed of Li₆PS₅Cl as a third solid electrolyte thereonto, and then applying a pressure of about 54 MPa thereto. Manufacture of the all-solid-state battery was completed by attaching a lithium-indium alloy to the solid electrolyte layer.

### Comparative Example 2

An all-solid-state battery was manufactured in the same manner as in Example 2 except that the composite cathode active material according to Comparative Manufacturing Example 3 was used.

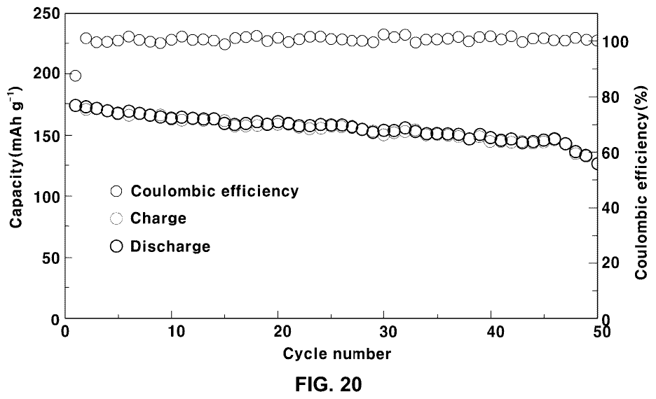

FIG. 19 shows evaluation results of electrochemical characteristics of the all-solid-state battery according to Example 2. FIG. 20 shows evaluation results of electrochemical characteristics of the all-solid-state battery according to Comparative Example 2.

Measurement conditions are as below.
Confining pressure during charging and discharging: 10 N/m².
Activation time: 3 hours.
Charging conditions: CC (˜3.7 V)−C/20 & CV (3.7 V)-limiting current of C/10.
Discharging conditions: CC (˜2.2 V)−C/20.

Referring to FIGS. 19 and 20, the initial capacity of the all-solid-state battery according to Example 2 is about 181.8 mAh/g, which is improved compared to the initial capacity of about 174.1 mAh/g of the all-solid-state battery according to Comparative Example 2. This may be caused by the interfacial resistance relief effect at the interfaces between the core part and the shell part including the alkali metal oxide due to introduction of the substituent element.

Further, after 50 charge cycles, the all-solid-state battery according to Example 2 exhibits capacity retention of about 82.9% and may thus have excellent long-term stability and long cycle life, compared to the all-solid-state battery according to Comparative Example 2 exhibiting capacity retention of about 72.5%.

As is apparent from the above description, according to embodiments of the present disclosure, there may be provided a composite cathode active material for lithium secondary batteries which may relieve high interfacial resistance between the cathode active material and a solid electrolyte and a manufacturing method thereof.

According to embodiments of the present disclosure, there may be provided a composite cathode active material for lithium secondary batteries having high chemical adsorption strength and excellent chemical stability and a manufacturing method thereof.

According to embodiments of the present disclosure, there may be provided a composite cathode active material for lithium secondary batteries having excellent lithium ion conductivity and a manufacturing method thereof.

Embodiments of the invention have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A composite cathode active material comprising:
a core part configured to enable intercalation and deintercalation of lithium; and
a shell part configured to cover surfaces of the core part and comprising an alkali metal oxide, wherein the alkali metal oxide comprises a substituent element substituted for a part of an alkali metal and having a greater oxidation number than the alkali metal.

2. The composite cathode active material of claim 1, wherein the substituent element comprises a non-transition metal.

3. The composite cathode active material of claim 1, wherein the alkali metal oxide is represented by (A₁₋ₐₓBₓ)MO₃, in which A comprises the alkali metal, B comprises at least one element selected from a group consisting essentially of magnesium (Mg), aluminum (Al), gallium (Ga), silicon (Si), germanium (Ge), tin (Sn), arsenic (As), antimony (Sb), and combinations thereof, M comprises at least one element selected from the group consisting essentially of niobium (Nb), tantalum (Ta), boron (B), zirconium (Zr), phosphorous (P), and combinations thereof, a indicates an oxidation number of B, and x satisfies 0.01≤x≤0.3.

4. The composite cathode active material of claim 1, wherein the alkali metal oxide is represented [(A₁₋ₐₓ(B1₁₋ₘB2ₘ)ₓ](M1₁₋ₙM2ₘ)O₃, in which A comprises the alkali metal, B1 and B2 are different from each other and independently comprise at least one element selected from a group consisting essentially of magnesium (Mg), aluminum (Al), gallium (Ga), silicon (Si), germanium (Ge), tin (Sn), arsenic (As), antimony (Sb), and combinations thereof, M1 and M2 are different from each other and independently comprise at least one element selected from the group consisting essentially of niobium (Nb), tantalum (Ta), boron (B), zirconium (Zr), phosphorous (P), and combinations thereof, oxidation numbers of B1 and B2 are the same, a indicates the oxidation number of B₁ or B₂, and m, n, and x satisfy 0≤m≤1, 0≤n≤1 and 0.01≤x≤0.3.

5. The composite cathode active material of claim 1, comprising:
98 wt % to 99.9 wt % of the core part; and
0.1 wt % to 2 wt % of the shell part.

6. The composite cathode active material of claim 1, wherein the alkali metal oxide has a crystal structure of a trigonal crystal structure and belongs to an R3c space group.

7. The composite cathode active material of claim 1, wherein the alkali metal and the substituent element occupy sites of a Wyckoff position 6a (0,0,0.283).

8. The composite cathode active material of claim 1, wherein the substituent element does not occupy sites of a Wyckoff position 6a (0,0,0).

9. The composite cathode active material of claim 1, wherein a unit cell volume of the alkali metal oxide is reduced depending on substitution of the substituent element for the part of the alkali metal, compared to a case in which there is no substituent element.

10. The composite cathode active material of claim 1, wherein a length of an axis a of the alkali metal oxide obtained through Rietveld analysis in X-ray diffraction is decreased depending on substitution of the substituent element for the part of the alkali metal, compared to a case in which there is no substituent element.

11. The composite cathode active material of claim 1, wherein a length of an axis c of the alkali metal oxide obtained through Rietveld analysis in X-ray diffraction is increased depending on substitution of the substituent element for the part of the alkali metal, compared to a case in which there is no substituent element.

12. The composite cathode active material of claim 1, wherein the alkali metal oxide is one in which a Bragg angle of at least one of (hkl) diffraction peaks among (012), (104), (110), and (113) obtained through Rietveld analysis in X-ray diffraction is shifted at a high angle depending on substitution of the substituent element for the part of the alkali metal, compared to a case in which there is no substituent element.

13. The composite cathode active material of claim 1, wherein the shell part is a conformal layer.

14. The composite cathode active material of claim 1, wherein adsorption energy of the alkali metal oxide to the core part is increased depending on substitution of the substituent element for the part of the alkali metal, compared to a case in which there is no substituent element.

15. The composite cathode active material of claim 1, wherein activation barrier energy of the alkali metal oxide is decreased depending on substitution of the substituent element for the part of the alkali metal, compared to a case in which there is no substituent element.

16. A lithium secondary battery comprising:
a cathode comprising the composite cathode active material of claim 1;
an anode; and
a solid electrolyte layer located between the cathode and the anode.

17. A method of manufacturing a composite cathode active material, the composite cathode active material comprising a core part that enables intercalation and deintercalation of lithium and a shell part covering surfaces of the core part, the method comprising:
preparing the core part;
preparing raw materials for an alkali metal oxide of the shell part, wherein the alkali metal oxide comprises a substituent element substituted for a part of an alkali metal and having a greater oxidation number than the alkali metal;
acquiring an intermediate by putting the core part and the raw materials into a solvent and agitating the core part and the raw materials in the solvent;
drying the intermediate; and
heat-treating the dried intermediate.

18. The method of claim 17, wherein the raw materials comprise alkoxides of respective elements configured to form the alkali metal oxide.

19. A method of manufacturing a composite cathode active material, the composite cathode active material comprising a core part that enables intercalation and deintercalation of lithium and a shell part covering surfaces of the core part and comprising an alkali metal oxide, the method comprising:
preparing raw materials for the alkali metal oxide;
acquiring a ground material by grinding the raw materials using a ball mill;
acquiring the alkali metal oxide by heat-treating the ground material; and
forming the shell part comprising the alkali metal oxide on the surfaces of the core part, wherein the alkali metal oxide comprises a substituent element substituted for a part of an alkali metal and having a greater oxidation number than the alkali metal.

20. The method of claim 19, wherein the raw materials comprise oxides of respective elements configured to form the alkali metal oxide.
